(19) United States
(12) Patent Application Publication
(10) Pub. No.: US 2008/0031201 A1
(43) Pub. Date: Feb. 7, 2008

(54) Plug and Play Network Telephone Communication Apparatus

(76) Inventor: Chun-Ching Lee, Taipei (TW)

Correspondence Address: LAW OFFICES OF LAI AND ASSOCIATES, P.C., 5800 RANCHESTER STE 200, HOUSTON, TX, 77036, US

(21) Appl. No.: 11/307,707

(22) Filed: Feb. 17, 2006

(51) Int. Cl. H04Q 7/24

(52) U.S. Cl. 370/338

(57) ABSTRACT

A plug and play network telephone communication apparatus includes a universal serial bus (USB) port, a USB controller, a memory and a network telephone communication controlling unit. The USB controller is connected to other components respectively for determining whether the USB port is connected to a computer. A network telephone communication program and data are built in the network telephone communication controlling unit. The network telephone communication controlling unit is activated instantly for automatically performing a sequence of actions so as to dial a network telephone after the apparatus is plugged to a USB port of the computer. There is no need to download and install the network telephone communication program from the computer. Address book establishment step could be eliminated as well. Therefore, a plug and play apparatus without installing is then provided to perform a network communication instantly.

### FIELD OF THE INVENTION

The present invention generally relates to a plug and play network telephone communication apparatus, and more particularly to a plug and play portable network telephone communication apparatus without installing.

### BACKGROUND OF THE INVENTION

Internet provides a common platform with data transfer for our world. Telecommunication industry recently develops the common platform to be a bridge for a far end communication so as to achieve cost down.

A network telephone is composed of packets transmitting to the platform. Transmitting in real-time is a primary problem must be overcome in order to ensure communication quality. Every company then provides many network architectures to ensure transmitting in real-time of voice packets so as to provide a better communication quality. The communication quality of the network telephone slightly differs from an analog switched telephone system after improving recently. Users and company users use the network telephone to communicate with other parties gradually.

The network telephone used by users can be provided from couples of portal sites by free download, such as YAHOO messenger, MSN, Skype, etc. A server of a site is then connected to input login data and to create related address books once a user downloads and installs above instant messengers. Contacts could be noticed by the instant messengers quickly that the user has already online. An operation way is that a network server records a connection and an email address for every user. When a successful login user would like to reconnect the server, the server would read contact data (e.g. email accounts) in the server successfully created by the user. A message for the user who has successfully online is sent to other online contacts. Meanwhile, online situations of contacts established by the user are transmitted to a computer of the user as well. The user or the contacts may set a connection for each other. Functions provided by above instant messengers include short message, mail, whiteboard, communication and image transmissions. In another word, both sides could communicate with each other through above data types.

A network telephone for use in a computer includes steps of: communication programs are downloaded. The communication programs are installed and executed so as to connect to a specific server. Login data are inputted. Contacts are established. Passwords and accounts are then obtained. The server is then reconnected to input passwords and accounts in order to successfully login. One party or multiple parties can be selected for establishing a connection. Communication software function is then chosen for communication. When a normal user uses communication software to perform a network telephone communication, the computer would record a user account and a password. However, the password and the user account must be reset once the computer crashes and data are unable to recover. Moreover, most of users are unable to remember login data completely and then embarrass this situation. If a user goes out or uses other computers, communication software must be re-downloaded, installed and login. The network telephone for use in a common computer may cause password and account stealing.

Accordingly, there are many shortcomings and security concerns for a network communication while installing and executing the communication software in the computer. Furthermore, downloading, installation and login may not easy for anybody. A solution must be provided to eliminate complex installation and usage for the network communication.

### SUMMARY OF THE INVENTION

The primary object of the present invention is to provide a network telephone communication apparatus that is applied for a computer. The network telephone communication apparatus has a universal serial bus (USB) port for plugging the computer. The network telephone communication apparatus has features, including plug and play, automatic start-up and automatic setup. Once the network telephone communication apparatus is plugged into USB ports of any computer without inputting any data, the computer could automatically finish the steps of network login and connection so as to perform dial-up connection. A plug and play network telephone communication apparatus is then provided.

The network telephone communication apparatus includes:

A USB port is plugged into a USB connector of the computer.

A USB controller has switching hub function and is connected to the USB port of the network telephone communication apparatus. A USB communication protocol is utilized to determine whether the USB port is connected to the computer;

A memory is dually connected to the USB controller. The USB controller could receive a computer control command. Data is then stored in the memory or could be fetched from the memory.

A network telephone communication controlling unit is connected to the USB controller. The network telephone communication controlling unit has built-in network telephone communication data (e.g. communication programs, accounts, login data, etc). The built-in network telephone communication data is stored in advance without creating by users.

A response is transmitted by the USB controller to the network telephone communication controlling unit once the USB controller determines that the USB port is connected to the computer. At this time the network telephone communication controlling unit would perform self test and self authentication. After success, the login data is fetched through the computer automatically connecting to internet. The computer is then connected to a specific server to obtain a connection, login, and to connect with relative contacts. After success, a user could communicate with a called party through peripheral hardware (e.g. a microphone or a speaker) of the computer. When a communication is finished, the user could remove the apparatus from the computer. The computer then determines that the apparatus has disconnected so as to automatically finish the telephone communication. The relative procedure of the network communication is further closed. When the apparatus is applied for the computer to perform the network communication, the relative data for dial-up connection procedure is built in the network telephone communication controller. Therefore, the computer does not need to install any communication program, to set login data of the user and to input additional contacts. The user could carry the apparatus for use in any computer with network connection. The user does not need to worry data thief or forget the login data. The apparatus has a memory which provides a portable storage media for the user, and the memory is practical.

The second object of the present invention is to provide a network telephone communication apparatus with digital music playing. In another word, a digital music player is set in the network telephone communication apparatus so as to provide digital music playing.

The third object of the present invention is to provide a network telephone communication apparatus with Bluetooth communication. In another word, a Bluetooth communication apparatus is set for the network telephone communication apparatus to achieve a wireless connection for an external Bluetooth communication apparatus so as to perform data conversion or communication.

The fourth object of the present invention is to provide a network telephone communication apparatus with keypad dialing, earphone head and microphone. The apparatus can be dialed up directly. An earphone and a microphone are inset into the apparatus for communication, thereby increasing conveniences.

### BRIEF DESCRIPTION OF THE DRAWINGS

FIG. 1 is a block diagram illustrating a portable network telephone communication apparatus according to a first preferred embodiment of the present invention;

FIG. 2 is a block diagram illustrating a portable network telephone communication apparatus according to a second preferred embodiment of the present invention;

FIG. 3 is a block diagram illustrating a portable network telephone communication apparatus according to a third preferred embodiment of the present invention;

FIG. 4 is a block diagram illustrating a portable network telephone communication apparatus according to a fourth preferred embodiment of the present invention; and

FIG. 5 is a flowchart illustrating an operation of the portable network telephone communication apparatus.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

Referring to FIG. 1, a block diagram illustrates a portable network telephone communication apparatus 10 according to a preferred embodiment of the present invention. The apparatus 10 comprises:

A universal serial bus (USB) port 11 is plugged into a USB connector of a computer.

A USB controller 20 is connected to the USB 11 and provides a signal detection and conversion.

A memory 21 is dually connected to the USB controller 20. The USB controller 20 could receive a computer control command. Data is then stored in the memory 21 or could be fetched from the memory 21. The memory 21 is a flash memory, an erasable programmable read-only memory (EPROM) and a chip memory. A flash drive can be composed of aforesaid three components and has data storage function.

A network telephone communication controlling unit 30 is also connected to the USB controller 20 and has built-in network communication related programs (e.g. at least a network telephone communication program) and data (e.g. at least a login account or login data). The network telephone communication controlling unit 30 can be integrated into the memory 21. In other words, the memory 21 can be partitioned into two independent portions through memory partition technique.

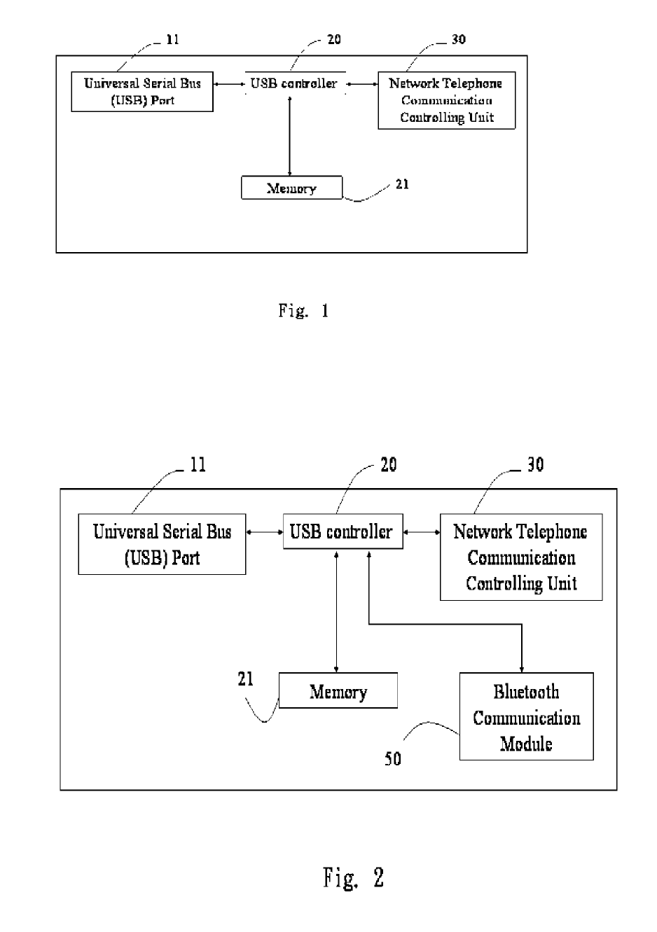

Referring to FIG. 2, a block diagram illustrates a portable network telephone communication apparatus according to another preferred embodiment of the present invention. The USB controller 20 includes switching hub function for connecting a digital music playing unit 40. The digital music playing unit 40 is for playing music signals with digital format, such as Moving Picture Expert Group Audio Layer-3 (MP3) music files.

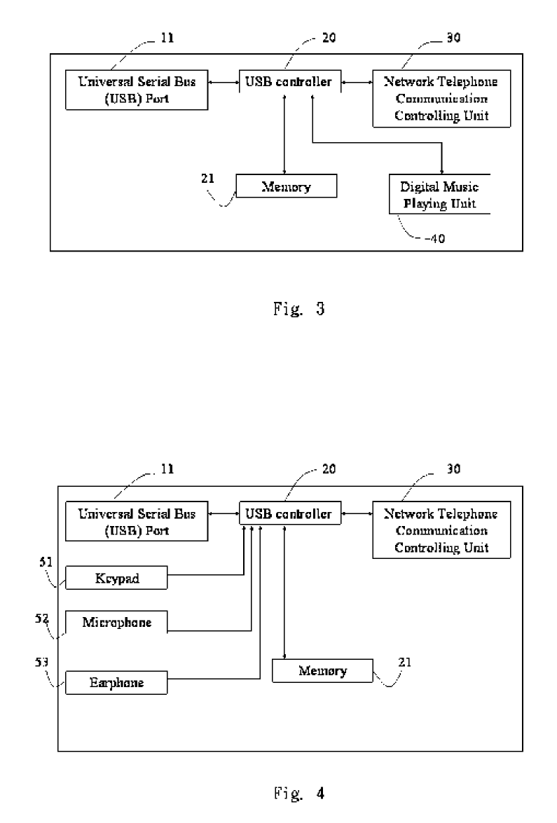

Referring to FIG. 3, a block diagram illustrates a portable network telephone communication apparatus according to a further preferred embodiment of the present invention. The apparatus further includes a Bluetooth communication module 50. The USB controller 20 integrates the Bluetooth communication module 50 because the USB controller 20 has switching hub function. An external Bluetooth communicator or an apparatus can be wirelessly connected.

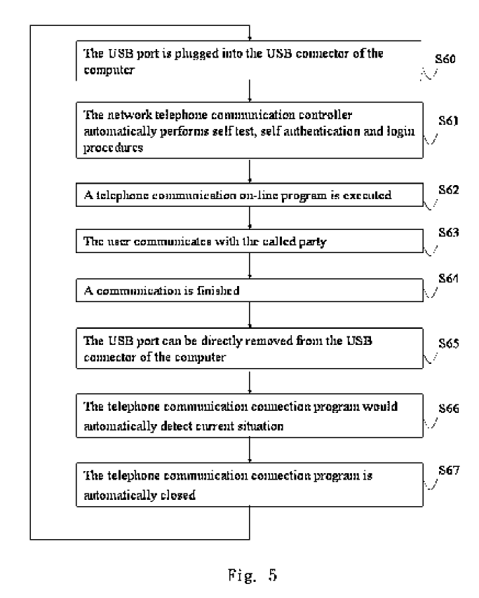

Referring to FIG. 4, a block diagram illustrates a portable network telephone communication apparatus according to a further preferred embodiment of the present invention. The USB controller 20 is further connected to a keypad 51, a microphone 52 and an earphone 53. User could set dial phone numbers through the keypad 51 and then communicates with the called party through the microphone and the earphone.

Referring to FIG. 5, a flowchart illustrates an operation of the portable network telephone communication apparatus according to FIG. 1 to FIG. 5. First, the USB port 11 is plugged into the USB connector of the computer S60 in order to connect to the computer. At this time, the USB controller 20 determines that the apparatus has connected to the computer through the communication function of the USB port 11. A response is transmitted to the network telephone communication controlling unit 30 simultaneously.

Once the USB port 11 is plugged into the computer, the network telephone communication controlling unit 30 automatically performs self test, self authentication and login procedures. After these tests are done (e.g. whether the network is normally connected) and the automatic login is success S61, the network telephone communication controlling unit 30 then executes a telephone communication connection program S62. The user only needs to select a called party, then connects to the called party and communicates with the called party by using the microphone of the computer S63.

When the user would like to finished the communication S64. Because the USB port 11 has hot-swap, the USB port 11 can be directly removed from the USB connector of the computer S65. The telephone communication connection program would automatically detect current situation S66. Lastly, the telephone communication connection program is automatically closed when the apparatus is removed S67. The telephone communication connection program would be released from the computer memory. The computer then returns to a former situation without storing any communication data.

The network telephone communication controlling unit 30 further includes a short message or an image transmission programs. In another word, an image and a short message can be transmitted by a keyboard and a camera from the computer to the called party when the network telephone communication controlling unit 30 is connected to the called party.

Using accounts for different areas can be purchased (e.g. Asia, America, etc) depending on actual demands. Because the areas of connected servers are different, a local phone charge is employed to reduce communication cost once a network telephone is connected to an analog switched telephone line. The apparatus has many accounts; therefore the apparatus could perform a selection interface after success in the self test and the self authentication. Built-in login data is then designed to be a selection list that provides the user to select one login data. The user then selects an appropriate communication environment or a communication rate for communication.

The user could set a network telephone data into the apparatus. The volume of the apparatus is smaller and easy to carry. The apparatus does not have an auto dialing network, but also has media storage with a massive capacity. The apparatus is plugged into the computer with a network connection and a microphone once the user would like to dial a network telephone. The telephone communication connection program is automatically executed so as to obtain a connection with the called party afterward. If the user would like to finish the communication, the apparatus is removed from the computer. The computer does not need to install or setup any communication program because related data for a telephone communication has been built in the network telephone communication apparatus. Account data lost could be eliminated completely. A plug and play network telephone communication apparatus with high security is then provided by the way mentioned above.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A plug and play network telephone communication apparatus, comprising:
a universal serial bus (USB) port for plugging into a USB connector of a computer;
a USB controller for connecting said USB port to determine whether said USB port is connected to said computer and for performing data conversion;
a memory for dually connecting said USB controller, wherein said USB controller receives computer control commands, data is then stored in said memory or is fetched from said memory so as to compose a computer storage media; and
a network telephone communication controlling unit for connecting said USB controller, said network telephone communication controlling unit having built-in network telephone communication programs and data, and for providing at least one account being executed, wherein when said plug and play network telephone communication apparatus is plugged into said computer, a telephone communication is performed and automatically loaded immediately, when said plug and play network telephone communication apparatus is removed, said telephone communication is automatically unloaded.

2. The plug and play network telephone communication apparatus of claim 1, wherein said USB controller has switching hub function, said USB controller integrates a digital music playing unit for playing a music signal with digital format.

3. The plug and play network telephone communication apparatus of claim 1, wherein said USB controller has switching hub function, said USB controller integrates a Bluetooth communication module for wirelessly connecting an external Bluetooth communicator or an apparatus.

4. The plug and play network telephone communication apparatus of claim 1, wherein said memory is a flash memory, an erasable programmable read-only memory (EPROM) and a chip memory.

5. The plug and play network telephone communication apparatus of claim 1, 2, 3 or 4, wherein said flash memory is partitioned into a portion of memory space through a partition procedure so as to integrate said network telephone communication controller into said portion of memory space.

6. The plug and play network telephone communication apparatus of claim 1, 2 or 3, wherein said network telephone communication controller includes a short message transmission program.

7. The plug and play network telephone communication apparatus of claim 1, 2, 3 or 6, wherein said network telephone communication controller includes an image capture apparatus and a transmission program.

8. The plug and play network telephone communication apparatus of claim 1, 2, 3 or 4, wherein said USB controller is connected to a keypad.

9. The plug and play network telephone communication apparatus of claim 1, 2, 3 or 4, wherein said USB controller is connected to a microphone and an earphone.

10. The plug and play network telephone communication apparatus of claim 8, wherein said USB controller is connected to a microphone and an earphone and a keypad.
